(19) United States
(12) Patent Application Publication
(10) Pub. No.: US 2011/0319550 A1
(43) Pub. Date: Dec. 29, 2011

(54) THERMOPLASTIC MOLDING COMPOUNDS CONTAINING STYRENE COPOLYMERS AND POLYAMIDES

(75) Inventors: Martin Weber, Maikammer (DE); Simone Schillo, Ludwigshafen (DE); Marko Blinzler, Mannheim (DE); Jürgen Deininger, Oftersheim (DE)

(73) Assignee: BASF SE, Ludwigshafen (DE)

(21) Appl. No.: 13/148,393

(22) PCT Filed: Jan. 29, 2010
(86) PCT No.: PCT/EP2010/051042

§ 371 Date: Aug. 8, 2011

(30) Foreign Application Priority Data
Feb. 6, 2009 (EP) 09152295.3

(51) Int. Cl. C08L 25/12; C08K 7/02; C08L 21/00; C08L 77/06; C08L 35/06

(52) U.S. Cl. 524/514; 525/179

(57) ABSTRACT

The thermoplastic molding composition comprises
a) as component A, from 3 to 79% by weight of one or more styrene copolymers which have no units derived from maleic anhydride,
b) as component B, from 15 to 91% by weight of one or more polyamides having, based on the entire component B, from 0.1 to 0.2% by weight of triacetonediamine (TAD) end groups,
c) as component C, from 5 to 50% by weight of one or more impact-modifying rubbers,
d) as component D, from 1 to 25% by weight of a styrene copolymer which, based on the entire component D, has from 1.9 to 2.3% by weight of units derived from maleic anhydride,
e) as component E, from 0 to 40% by weight of further rubbers,
f) as component F, from 0 to 50% by weight of one or more fibrous or particulate fillers,
g) as component G, from 0 to 40% by weight of further additives,
where the molding composition comprises less than 0.1% by weight of phthalic anhydride and the total amount of components A to D and, if appropriate, E to G is 100% by weight.

The invention relates to thermoplastic molding compositions comprising styrene copolymers and comprising polyamides, to processes for their production, and to their use, and also to moldings, fibers, and foils produced therefrom.

Polymeric blends composed of styrene copolymers and of polyamides are known per se. Binary blends composed of polyamides and of styrene copolymers have very poor toughness values, due to the incompatibility of polyamide with, for example, styrene-acrylonitrile copolymer. The toughness of blends can be raised significantly by using functionalized styrene-acrylonitrile copolymers (SAN copolymers). Products of this type moreover have interesting properties such as high impact resistance, and good flowability, and chemicals resistance. Particularly suitable compatibilizers are styrene-acrylonitrile-maleic anhydride terpolymers, styrene-N-phenylmaleimide-maleic anhydride terpolymers, and methyl methacrylate-maleic anhydride copolymers. It is assumed that the amino or carboxy end groups of the polyamides react with the functional groups of the co- and terpolymers mentioned, with in-situ production of copolymers which bring about the compatibility between the styrene copolymer phase and the polyamide phase. Polymer mixtures of this type with a modified interface are generally termed polymer alloys.

The styrene copolymer-polyamide blends known hitherto have insufficient UV resistance for many applications. Weathering resistance can by way of example be improved by use of impact modifiers which have no olefinic double bonds. The use of these can lead not only to higher materials costs but also to a significant reduction in notched impact resistance at low temperatures. Another possibility is to use polyamides having sterically hindered piperidine end groups as HALS stabilizers. However, when processing conditions are unfavorable, use of, for example, molding compositions comprising triacetonediamine (TAD) leads to a reduction in fracture energy at low temperatures.

WO 2005/040281 discloses thermoplastic molding compositions which comprise polyamide having TAD end groups, styrene-acrylonitrile-maleic anhydride terpolymers, graft rubbers, and, frequently, phthalic anhydride. The property profile of the molding compositions described is not ideal for all applications.

It is an object of the present invention to provide thermoplastic molding compositions based on styrene copolymers and polyamides, with improved colorfastness and good flowability, and also with good impact resistance at ambient temperature and at low temperatures, and also with improved fracture energy at low temperatures.

According to the invention, the object is achieved via a thermoplastic molding composition comprising
a) as component A, from 3 to 79% by weight of one or more styrene copolymers which have no units derived from maleic anhydride,
b) as component B, from 15 to 91% by weight of one or more polyamides having, based on the entire component B, from 0.1 to 0.2% by weight of triacetonediamine (TAD) end groups,
c) as component C, from 5 to 50% by weight of one or more impact-modifying rubbers,
d) as component D, from 1 to 25% by weight of a styrene copolymer which, based on the entire component D, has from 1.9 to 2.3% by weight of units derived from maleic anhydride,
e) as component E, from 0 to 40% by weight of further rubbers,
f) as component F, from 0 to 50% by weight of one or more fibrous or particulate fillers,
g) as component G, from 0 to 40% by weight of further additives,
   where the molding composition comprises less than 0.1% by weight of phthalic anhydride and the total amount of components A to D and, if appropriate, E to G is 100% by weight. The molding composition can also be composed of the ingredients mentioned.

According to the invention, it has been found that a specific combination of the TAD end group content in the polyamide with a specific proportion of styrene copolymers comprising maleic anhydride units leads to the advantages of the invention.

The proportion of component A in the thermoplastic molding compositions is from 3 to 79% by weight, preferably from 10 to 25% by weight, in particular from 14 to 19% by weight.

The amount of component B comprised in the thermoplastic compositions is from 15 to 91% by weight, preferably from 25 to 70% by weight, in particular from 36 to 53% by weight.

The amount of component C comprised in the thermoplastic molding composition is from 5 to 50% by weight, preferably from 15 to 45% by weight, in particular from 28 to 35% by weight.

The amount of component D comprised in the thermoplastic molding compositions is from 1 to 25% by weight, preferably from 2 to 10% by weight, in particular from 4 to 6% by weight.

The amount of component E comprised in the thermoplastic molding compositions is from 0 to 40% by weight, preferably from 0 to 30% by weight, in particular from 0 to 17% by weight. If component E is present, the minimum amount is 1% by weight.

The amount of component F comprised in the thermoplastic molding compositions is from 0 to 50% by weight, preferably from 0 to 25% by weight, in particular from 0 to 8% by weight. If component F is present, its minimum amount comprised is preferably 0.1% by weight.

The amount of component G comprised in the thermoplastic molding compositions is from 0 to 40% by weight, preferably from 0 to 30% by weight, in particular from 0 to 17% by weight. If component G is present, its minimum amount is 0.1% by weight.

If one or more of components E to G is/are present, the maximum possible amount of components A-D is correspondingly reduced by the minimum amount that is to be added of components E-G, thus always giving a total amount of 100% by weight.

### Component A

The thermoplastic molding compositions of the invention comprise, as component A, one or more styrene copolymers which have no units derived from maleic anhydride. Any desired suitable comonomers can be present alongside styrene here in the copolymers. Preference is given to styrene-acrylonitrile copolymer or α-methylstyrene-acrylonitrile copolymer.

In principle, any of the styrene-acrylonitrile copolymers or α-methylstyrene-acrylonitrile copolymers known to the person skilled in the art and described in the literature, or a mixture thereof, can be used as component A of the thermoplastic matrix M, as long as the intrinsic viscosity IV of the mixtures thereof (measured to DIN 53727 at 25° C. as a 0.5% strength by weight solution in dimethylformamide; this measurement method also applying to all of the intrinsic viscosities IV mentioned hereinafter) is smaller than or equal to 85 ml/g.

Preferred components A are composed of from 50 to 90% by weight, preferably from 60 to 80% by weight, in particular from 65 to 78% by weight, of styrene, and from 10 to 50% by weight, preferably from 20 to 40% by weight, in particular from 22 to 35% by weight of acrylonitrile, and also from 0 to 5% by weight, preferably from 0 to 4% by weight, in particular from 0 to 3% by weight, of further monomers, where each of the % by weight values is based on the weight of component A, and they give a total of 100% by weight.

Further preferred components A are composed of from 50 to 90% by weight, preferably from 60 to 80% by weight, in particular from 65 to 78% by weight, of α-methylstyrene, and from 10 to 50% by weight, preferably from 20 to 40% by weight, in particular from 22 to 35% by weight, of acrylonitrile, and also from 0 to 5% by weight, preferably from 0 to 4% by weight, in particular from 0 to 3% by weight, of further monomers, where each of the % by weight values is based on the weight of component A, and they give a total of 100% by weight.

Equally preferred components A are mixtures of said styrene-acrylonitrile copolymers and of said α-methylstyrene-acrylonitrile copolymers.

Abovementioned further monomers that can be used are any of the copolymerizable monomers which differ from maleic anhydride, examples being p-methylstyrene, tert-butylstyrene, vinylnaphthalene, alkyl acrylates and/or alkyl methacrylates, for example those having C₁-C₈-alkyl radicals, N-phenylmaleimide, or a mixture thereof.

The copolymers of component A can be produced by methods known per se. By way of example, they can be produced via free-radical polymerization, in particular via emulsion polymerization, suspension polymerization, solution polymerization, or bulk polymerization.

The styrene copolymers are preferably rubber-free.

The thermoplastic molding compositions of the invention comprise, as component B, one or more polyamides having, based on the entire component B, from 0.1 to 0.2% by weight of triacetonediamine (TAD) end groups.

The materials here can also be mixtures of polyamides having TAD end groups with polyamides without TAD end groups. It is important that the total amount of triacetonediamine end groups present, based on component B, is from 0.1 to 0.2% by weight. The amount of TAD end groups preferably present is from 0.14 to 0.18% by weight, in particular from 0.15 to 0.17% by weight.

According to the invention, the component B used comprises a polyamide having at least one end group that can derive from the piperidine compound TAD. It is also possible to use, as component B, a mixture composed of two or more different polyamides. By way of example, polyamides having a different underlying structure but having an identical end group can be used. However, it is also possible to use polyamides having the same underlying skeleton and having end groups which derive from different piperidine compounds. In another possibility, a mixture is used, composed of polyamides which have different contents of end groups which derive from the piperidine compounds.

Polyamides are homopolymeric or copolymeric, synthetic long-chain polyamides in which repeating amide groups are an essential constituent of the main polymer chain. Examples of these polyamides are nylon-6 (polycaprolactam), nylon-6,6 (polyhexamethyleneadipamide), nylon-4,6 (polytetramethyleneadipamide), nylon-5,10 (polypentamethyleneadipamide), nylon-6,10 (polyhexamethylenesebacamide), nylon-7 (polyenantholactam), nylon-11 (polyundecanolactam), nylon-12 (polydodecanolactam). As is known, these polyamides have the generic name nylon.

There are in principle two processes for producing polyamides.

Polymerization starting from dicarboxylic acids and from diamines, as with polymerization starting from amino acids, reacts the amino and carboxy end groups of the starting monomers or starting oligomers with one another to form an amide group and water. The water can then be removed from the polymeric material. The polymerization starting from carboxamides reacts the amino and amide end groups of the starting monomers or starting oligomers with one another to form an amide group and ammonia. The ammonia can then be removed from the polymeric material.

Examples of suitable starting monomers or starting oligomers for preparing polyamides are
(1) C₂-C₂₀, preferably C₃-C₁₈, amino acids, such as 6-aminocaproic acid, 11-amino-undecanoic acid, and also dimers, trimers, tetramers, pentamers and hexamers thereof,
(2) amides of C₂-C₂₀ amino acids, for example 6-aminocaproamide, 11-aminoundecanamide, and also dimers, trimers, tetramers, pentamers and hexamers of these,
(3) products of the reaction of
   (3a) C₂-C₂₀, preferably C₂-C₁₂, alkylenediamines, such as tetramethylenediamine or preferably hexamethylenediamine,
with
   (3b) a C₂-C₂₀, preferably C₂-C₁₄, aliphatic dicarboxylic acid, such as sebacic acid, decanedicarboxylic acid or adipic acid,
and also dimers, trimers, tetramers, pentamers and hexamers of these reaction products,
(4) products of the reaction of (3a) with
   (4b) a C₈-C₂₀, preferably C₈-C₁₂, aromatic dicarboxylic acid or derivatives thereof, for example chlorides, e.g. 2,6-naphthalenedicarboxylic acid, preferably isophthalic acid or terephthalic acid,
and also dimers, trimers, tetramers, pentamers and hexamers of these reaction products,
(5) products of the reaction of (3a) with
   (5b) a C₉-C₂₀, preferably C₉-C₁₈, arylaliphatic dicarboxylic acid or derivatives thereof, for example chlorides, e.g. o-, m- or p-phenylenediacetic acid,
and also dimers, trimers, tetramers, pentamers and hexamers of these reaction products,
(6) products of the reaction of
   (6a) C₆-C₂₀, preferably C₆-C₁₀, aromatic diamines, such as m- or p-phenylenediamine, with (3b)
and also dimers, trimers, tetramers, pentamers and hexamers of these reaction products,
(7) products of the reaction of
   (7a), C₇-C₂₀, preferably C₈-C₁₈, arylaliphatic diamines, such as m- or p-xylylenediamine, with (3b)
and also dimers, trimers, tetramers, pentamers and hexamers of these reaction products, and
(8) monomers or oligomers of a C₂-C₂₀, preferably C₂-C₁₈, arylaliphatic or preferably aliphatic lactam, such as enantholactam, undecanolactam, dodecanolactam or caprolactam,
   and also homopolymers or copolymers or mixtures of these starting monomers or starting oligomers.

Preference is given here to those starting monomers or starting oligomers which polymerize to give the polyamides nylon-6, nylon-6,6, nylon-4,6, nylon-5,10, nylon-6,10, nylon-7, nylon-11, or nylon-12, in particular to give nylon-6 or nylon-6,6.

The triacetonediamine (TAD) end groups derive from 4-amino-2,2,6,6-tetramethylpiperidine. The TAD can have been linked to the polyamide by way of an amino or carboxy group. By way of example, therefore, the compound involved can be 4-carboxy-2,2,6,6-tetramethylpiperidine.

The production of the polyamides B is known per se or can use processes known per se. The polymerization or polycondensation of the starting monomers can therefore by way of example be undertaken in the presence of the piperidine compounds, under conventional process conditions, and the reaction here can take place continuously or batchwise. However, the piperidine compounds can also be combined with a type of chain regulator usually used for the production of polyamides. information concerning suitable processes is found by way of example in WO 95/28443, WO 99/41297, or DE-A 198 12 135. The TAD compound is bonded to the polyamide via reaction of at least one of the amide-forming groups R⁷. Steric hindrance prevents the secondary amino groups of the piperidine ring systems from reacting here.

It is also possible to use polyamides that have been produced via copolycondensation or two or more of the abovementioned monomers or their components, e.g. copolymers composed of adipic acid, isophthalic acid, or terephthalic acid and hexamethylenediamine, or copolymers composed of caprolactam, terephthalic acid, and hexamethylenediamine. These semiaromatic copolyamides comprise from 40 to 90% by weight of units which derive from terephthalic acid and from hexamethylenediamine. A small proportion of the terephthalic acid, preferably not more than 10% by weight of the entire aromatic dicarboxylic acids used, can be replaced by isophthalic acid or other aromatic dicarboxylic acids, preferably those in which the carboxy groups are in para-position.

A semiaromatic polyamide is nylon-9,T, which derives from nonanediamine and terephthalic acid.

Other monomers that can be used are cyclic diamines, such as those of the general formula V

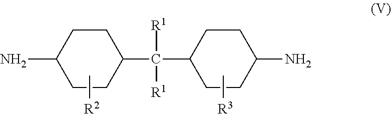

in which
R¹ is hydrogen or a C₁-C₄-alkyl group,
R² is a C₁-C₄-alkyl group or hydrogen, and
R³ is a C₁-C₄-alkyl group or hydrogen.

Particularly preferred diamines V are bis(4-aminocyclohexyl)methane, bis(4-amino-3-methylcyclohexyl)methane, bis(4-aminocyclohexyl)-2,2-propane or bis(4-amino-3-methylcyclohexyl)-2,2-propane.

Other diamines V that may be mentioned are 1,3- or 1,4-cyclohexanediamine or isophoronediamine. The semiaromatic copolyamides comprise, alongside the units which derive from terephthalic acid and from hexamethylenediamine, units which derive from ε-caprolactam, and/or units which derive from adipic acid and from hexamethylenediamine.

The proportion of units which derive from ε-caprolactam is up to 50% by weight, preferably from 20 to 50% by weight, in particular from 25 to 40% by weight, whereas the proportion of units which derive from adipic acid and from hexamethylenediamine is up to 60% by weight, preferably from 30 to 60% by weight, and in particular from 35 to 55% by weight.

It is also possible that the copolyamides comprise not only units of ε-caprolactam but also units of adipic acid and hexamethylenediamine; in this case, care has to be taken that the proportion of units free from aromatic groups is at least 10% by weight, preferably at least 20% by weight. There is no particular restriction here on the ratio of the units which derive from ε-caprolactam and from adipic acid and from hexamethylenediamine.

Materials which have proven particularly advantageous for many applications are polyamides having from 50 to 80% by weight, in particular from 60 to 75% by weight, of units which derive from terephthalic acid and from hexamethylenediamine, and having from 20 to 50% by weight, preferably from 25 to 40% by weight, of units which derive from ε-caprolactam.

The semiaromatic copolyamides can by way of example be produced by the processes described in EP-A-129 195 and EP-A-129 196.

Preferred semiaromatic polyamides are those whose content of triamine units, in particular units of dihexamethylenetriamine, is below 0.555% by weight. Particular preference is given to those semiaromatic polyamides whose triamine contents are 0.3% by weight or less.

Preference is given to linear polyamides whose melting point is above 200° C.

Preferred polyamides are polyhexamethyleneadipamide, polyhexamethylene-sebacamide and polycaprolactam, and also nylon-6/6,T and nylon-6,6/6,T, and also polyamides which comprise cyclic diamines as comonomers. The relative viscosity of the polyamides is generally from 2.0 to 5, determined in a 1% strength by weight solution in 96% strength sulfuric acid at 23° C., corresponding to a molecular weight (number average) of about 15 000 to 45 000. Preference is given to use of polyamides whose relative viscosity is from 2.4 to 3.5, in particular from 2.5 to 3.4.

Mention may also be made of polyamides obtainable by way of example via condensation of 1,4-diaminobutane with adipic acid at an elevated temperature (nylon-4,6). Production processes for polyamides of this structure are described by way of example in EP-A 38 094, EP-A 38 582, and EP-A 39 524.

The thermoplastic molding compositions comprise, as component C, impact-modifying rubbers, in particular graft rubbers. For the purposes of the invention, graft rubbers are core-shell rubbers which can also have a multishell structure. It is possible here to use conventional impact modifiers which are suitable for polyamides.

Rubbers which increase the toughness of polyamides generally have two essential features: they comprise an elastomeric fraction whose glass transition temperature is below −10° C., preferably below −30° C., and they comprise at least one functional group which can interact with the polyamide. Examples of suitable functional groups are carboxylic acid groups, carboxylic anhydride groups, carboxylic ester groups, carboxamide groups, carboximide groups, amino groups, hydroxy groups, epoxy groups, urethane groups, and oxazoline groups.

The following may be mentioned as examples of rubber which increase the toughness of the blends:

EP rubbers or EPDM rubbers, respectively grafted with the abovementioned functional groups. Examples of suitable graft reagents are maleic anhydride, itaconic acid, acrylic acid, glycidyl acrylate, and glycidyl methacrylate.

These monomers can be grafted in the melt or in solution onto the polymer, if appropriate in the presence of a free-radical generator, such as cumene hydroperoxide.

Mention may also be made of copolymers of α-olefins. The α-olefins are usually monomers having from 2 to 8 carbon atoms, preferably ethylene and propylene. Comonomers that have proven suitable are alkyl acrylates or alkyl methacrylates which derive from alcohols having from 1 to 8 carbon atoms, preferably from ethanol, butanol, or ethylhexanol, and also reactive comonomers, such as acrylic acid, methacrylic acid, maleic acid, maleic anhydride, or glycidyl (meth)acrylate, and also vinyl esters, in particular vinyl acetate. It is also possible to use a mixture of various comonomers. Materials which have proved particularly suitable are copolymers of ethylene with ethyl or butyl acrylate and acrylic acid and/or maleic anhydride.

The copolymers can be produced in a high-pressure process at a pressure of from 400 to 4500 bar or via grafting of the comonomers onto the poly-α-olefin. The proportion of the α-olefin, based on the copolymer, is generally in the range from 99.95 to 55% by weight.

A further group of suitable elastomers are core-shell graft rubbers. The core-shell graft rubbers are graft rubbers which are produced in emulsion and which are composed of at least one hard and one soft constituent. A hard constituent is usually a polymer whose glass transition temperature is at least 25° C., and a soft constituent is usually a polymer whose glass transition temperature is at most 0° C. These products have a structure composed of a core and of at least one shell, and the structure here is the result of the sequence of addition of the monomers. The soft constituents derive inter alia from butadiene, isoprene, alkyl acrylates, alkyl methacrylates or siloxanes, and, if appropriate, from further comonomers. Suitable siloxane cores can by way of example by produced from cyclic oligomeric octamethyltetrasiloxane or tetravinyltetramethyltetrasiloxane, or tetravinyltetramethyltetrasiloxane. These can by way of example be reacted with γ-mercaptopropylmethyldimethoxysilane in a ring-opening cationic polymerization reaction, preferably in the presence of sulfonic acids, to give the soft siloxane cores. The siloxanes can also be crosslinked, for example by carrying out the polymerization reaction in the presence of silanes having hydrolyzable groups, such as halogen or alkoxy groups, examples being tetraethoxysilane, methyltrimethoxysilane, or phenyltrimethoxysilane. Examples of suitable comonomers that may be mentioned here are styrene, acrylonitrile, and crosslinking or graft-active monomers having more than one polymerizable double bond, e.g. diallyl phthalate, divinylbenzene, butanediol diacrylate or triallyl (iso)cyanurate. The hard constituents derive inter alia from styrene, α-methylstyrene, and copolymers of these, and preferred comonomers that may be listed here are acrylonitrile, methacrylonitrile, and methyl methacrylate.

Preferred core-shell graft rubbers comprise a soft core and a hard shell, or a hard core, a first soft shell, and at least one further hard shell. According to the invention, it is possible here to incorporate functional groups, such as carbonyl groups, carboxylic acid groups, anhydride groups, carboxamide groups, carboximide groups, carboxylic ester groups, amino groups, hydroxy groups, epoxy groups, oxazoline groups, urethane groups, urea groups, lactam groups, or halobenzyl groups, and this is preferably achieved here via addition of suitably functionalized monomers during the polymerization of the final shell. Examples of suitable functionalized monomers are maleic acid, maleic anhydride, mono- or diesters of maleic acid, tert-butyl (meth)acrylate, acrylic acid, glycidyl (meth)acrylate, and vinyloxazoline. The proportion of monomers having functional groups is generally from 0.1 to 25% by weight, preferably from 0.25 to 15% by weight, based on the total weight of the core-shell graft rubber. The ratio by weight of soft to hard constituents is generally from 1:9 to 9:1, preferably from 3:7 to 8:2.

Rubbers of this type which increase the toughness of polyamides are known per se and are described by way of example in EP-A 208 187.

Another group of suitable impact modifiers is that of thermoplastic polyester elastomers. Polyester elastomers here are segmented copolyetheresters which comprise long-chain segments which generally derive from poly(alkylene) ether glycols and short-chain segments which derive from low-molecular-weight diols and dicarboxylic acids. Products of this type are known per se and are described in the literature, e.g. in U.S. Pat. No. 3,651,014. Corresponding products are also commercially available as Hytrel® (Du Pont), Arnitel® (Akzo), and Pelprene® (Toyobo Co. Ltd.).

It is also possible, of course, to use a mixture of various rubbers.

It is preferable that the materials are graft rubbers which comprise no ethylenically unsaturated hydrocarbon residues (olefinic double bonds). They are particularly preferably ASA rubbers (acrylonitrile-styrene-alkyl acrylate rubbers).

Polymerization of the hard phase also produces subordinate amounts of ungrafted fractions. These are counted with the hard phase. It is also possible to use a mixture of various rubbers, and it is preferable here that the soft-phase fractions of the rubbers used differ by at least 5% by weight.

The thermoplastic molding compositions of the invention comprise, as component D, styrene copolymers which have, based on the entire component D, from 1.9 to 2.3% by weight of units derived from maleic anhydride. This proportion is preferably from 2.0 to 2.2% by weight, in particular about 2.1% by weight.

It is particularly preferable that component D is a styrene-acrylonitrile-maleic anhydride terpolymer.

The proportion of acrylonitrile in the terpolymer, based on the entire terpolymer, is preferably from 10 to 30% by weight, particularly preferably from 15 to 30% by weight, in particular from 20 to 25% by weight. The residue is composed of styrene.

The molar masses M_{w} of the copolymers are generally from 30 000 to 500 000 g/mol, preferably from 50 000 to 250 000 g/mol, in particular from 70 000 to 200 000 g/mol, determined via GPC, using tetrahydrofuran (THF) as eluent, and using polystyrene calibration.

The copolymers can be produced via free-radical-generating polymerization of the corresponding monomers. The production process is explained in more detail by way of example in WO 2005/040281, page 10, line 31 to page 11, line 8.

It is moreover also possible to use styrene-N-phenylmaleimide-maleic anhydride terpolymers. Reference can also be made to the descriptions in EP-A-0 784 080, and also DE-A-100 24 935, and to DE-A-44 07 485, the description of component B of that specification, on pages 6 and 7.

The thermoplastic molding compositions of the invention can comprise, as component E, further rubbers which differ from component C. If graft rubbers are used as component C, then component E comprises no graft rubbers. Component E can also be omitted, in particular if there are no graft rubbers as component C. Examples of rubbers that can be used are ethylene copolymers or functionalized EP rubbers or SEBS block rubbers. For a further description of component E, reference can be made to DE-A-195 26 855, pages 10 and 11, with the component E described there.

The thermoplastic molding compositions of the invention can comprise, as component F, one or more fibrous or particulate fillers. Preferred fibrous fillers or fibrous reinforcing materials are carbon fibers, potassium titanate whiskers, aramid fibers, and particularly glass fibers. When glass fibers are used, these can have been provided with size and with a coupling agent, to improve compatibility with the matrix material. The diameter of the carbon fibers and glass fibers used is generally in the range from 6 to 20 μm. The form in which the glass fibers are incorporated can either be that of short glass fibers or else that of continuous-filament strands (rovings). The preferred average length of the glass fibers in a finished injection molding is in the range from 0.08 to 0.5 mm.

The form in which carbon fibers or glass fibers are used can also be that of wovens, mats, or glass silk rovings.

Suitable particulate fillers are amorphous silica, magnesium carbonate (chalk), powdered quartz, mica, talc, feldspar, glass beads, and in particular calcium silicates, such as wollastonite, and kaolin (in particular calcined kaolin).

Particularly preferred combinations of fillers are those composed of glass fibers and wollastonite.

Further additives can be used as component G. Examples of these are flame retardants, dyes, pigments, or stabilizers, examples being heat stabilizers or UV stabilizers, and also lubricants, or demolding aids.

The invention also provides a process for the production of the thermoplastic compositions described above, where components A-D and, if appropriate, E-G are mixed with one another in any desired sequence.

The sequence in which the components are mixed is as desired. By way of example, it is possible to produce the molding compositions by mixing the starting components in conventional mixing apparatuses, such as screw-based extruders, preferably twin-screw extruders, or in Brabender mixers or Banbury mixers, or else in kneaders, and then extruding the same. The extrudate is cooled and comminuted. The sequence of mixing components can be varied, and it is therefore possible to premix two or, if appropriate, three components. However, it is also possible to mix all of the components together.

Intensive mixing is advantageous in order to obtain maximum homogeneity of mixture. Average mixing times required for this are generally from 0.2 to 30 minutes at temperatures of from 240 to 300° C., preferably from 245 to 290° C. The extrudate is generally cooled and comminuted.

The molding compositions of the invention feature inter alia improved fracture energy at −30° C. They moreover also feature less tendency toward formation of mold deposit.

The thermoplastic molding compositions of the invention can be used for the production of moldings, fibers, and foils. They are in particular used for the production of moldings. The moldings are preferably used here in motor-vehicle components or in electronic equipment.

The molding compositions of the invention exhibit particular advantages in the production of moldings having pale color, since they have very little intrinsic color, and give no, or only marginal, texturing during processing by injection molding.

The invention also provides moldings, fibers, and foils composed of the molding compositions of the invention.

The examples below provide further explanation of the invention.

### EXAMPLES

### Production and Testing of Molding Compositions

The intrinsic viscosity of the polyamides is determined to DIN 53 727 on 0.5% strength by weight solutions in 96% by weight sulfuric acid. The intrinsic viscosity of the styrene co- or terpolymers is determined in 0.5% strength by weight DMF solution at 25° C.

The heat resistance of the specimens was determined by means of the Vicat softening point. The Vicat softening point was determined to DIN 53 460, using a force of 49.05 N and a temperature rise of 50 K per hour, on ISO specimens.

The notched impact resistance of the products was determined on ISO specimens to ISO 179 1eA.

Flowability was determined to ISO 1133, at 240° C. with a loading of 5 kg. The color of the specimens was determined visually after 1000 h of Xenotest aging, and was classified as from 1 (no discoloration) to 5 (severe yellowing).

Fracture energy was determined to ISO 6603 on sheets (60×60×3 mm³) at −30° C. Total energy Wₜ was used here.

The tendency of the molding compositions toward emission was determined as total C emission to VDA 277.

### Component A

Styrene-acrylonitrile copolymer using 75% by weight of styrene and 25% by weight of acrylonitrile and having intrinsic viscosity of 80 ml/g (determined in 0.5% strength by weight DMF solution at 25° C.)

### Component B 1

The polyamide B 1 used comprised a nylon-6, obtained from ε-caprolactam, with intrinsic viscosity of 150 ml/g (measured at 0.5% strength by weight in 96% strength sulfuric acid), e.g. Ultramid® B 3.

### Component B 2

The polyamide B 2 used comprised a nylon-6, obtained from s-caprolactam, with intrinsic viscosity of 130 ml/g (measured at 0.5% strength by weight in 96% strength sulfuric acid) and having a proportion of 0.16% by weight of triacetonediamine.

### Component B V

The following substances were metered into a 250 l autoclave:

50 kg of caprolactam, 810 g of deionized water, 1.25 kg of 4-amino-2,2,6,6-tetramethylpiperidine (TAD). The mixture was heated to 270° C. for one hour. The mixture was kept under these conditions for 30 minutes, and then the pressure was slowly reduced. In order to achieve a further increase in conversion, the reaction mixture was kept in vacuo (about 600 mbar) for 90 minutes. The reaction product was then discharged from the reaction vessel and pelletized. The pellets obtained were extracted with water heated to 90° C. and then dried. The intrinsic viscosity of the resultant polyamide was 53 ml/g and its proportion of TAD was 2.3% by weight.

### Component C 1

Graft rubber using 62% by weight of polybutadiene in the core and 38% by weight of a graft shell composed of 75% by weight of styrene and 25% by weight of acrylonitrile. Average particle size about 400 nm.

### Component C 2

Graft rubber using 70% by weight of polybutadiene in the core and 30% by weight of a graft shell composed of 75% by weight of styrene and 25% by weight of acrylonitrile. Average particle size about 370 nm.

### Component DV 1

The component DV 1 used comprised a styrene-acrylonitrile-maleic anhydride terpolymer, its constitution being 74.5/24.5/1.0 (% by weight), intrinsic viscosity: 66 ml/g.

### Component DV 2

The component DV 2 used comprised a styrene-acrylonitrile-maleic anhydride terpolymer, its constitution being 74.6/23.7/1.7 (% by weight), intrinsic viscosity: 67 ml/g.

### Component D 3

The component D 3 used comprised a styrene-acrylonitrile-maleic anhydride terpolymer, its constitution being 74.4/23.5/2.1 (% by weight), intrinsic viscosity: 66 ml/g.

### Component DV 4

The component DV 4 used comprised a styrene-acrylonitrile-maleic anhydride terpolymer, its constitution being 74.6/23.5/2.9 (% by weight), intrinsic viscosity: 66 ml/g.

### Component F

Chopped glass fiber with polyurethane size, fiber diameter 14 μm.

### Production of Molding Compositions of the Invention

The components were mixed at a melt temperature of from 240 to 260° C. in a twin-screw extruder. The melt was passed through a water bath and pelletized.

The results of the tests are listed in table 1:

TABLE 1

| | Molding composition | | | | | | | | | |
|---|---|---|---|---|---|---|---|---|---|---|
| | V 1 | V 2 | V 3 | 4 | V 5 | 6 | V 7 | 8 | 9 | V 10 |
| A | 19 | 19 | 19 | 19 | 19 | 14 | 14 | 14 | 18.2 | 18.2 |
| B 1 | — | 38.3 | 38.3 | — | — | — | 53 | — | — | — |
| B 2 | 41 | — | — | 41 | 41 | 53 | — | 53 | 36.8 | 36.8 |
| BV | — | 2.7 | 2.7 | — | — | — | — | — | — | — |
| C 1 | 35 | 35 | 35 | 35 | 35 | 28 | 28 | 23 | 32 | 32 |
| C 2 | — | — | — | — | — | — | — | 5 | — | — |
| DV 1 | 5 | 5 | — | — | — | — | 5 | — | — | — |
| DV 2 | — | — | 5 | — | — | — | — | — | — | 5 |
| D3 | — | — | — | 5 | — | 5 | — | 5 | 5 | — |
| DV 4 | — | — | — | — | 5 | — | — | — | — | — |
| F | — | — | — | — | — | — | — | — | 8 | 8 |
| Vicat B | 103 | 101 | 101 | 104 | 103 | 115 | 115 | 115 | 109 | 109 |
| [° C.] | | | | | | | | | | |
| MVI | 12.9 | 11.5 | 11.8 | 19.2 | 16.4 | 25.3 | 27.2 | 26.1 | 5.3 | 3.7 |
| [ml/10′] | | | | | | | | | | |
| ak, RT | 24.3 | 21.2 | 51 | 60.2 | 25.3 | 63.4 | 24.3 | 68.4 | 10.7 | 8.3 |
| [kJ/m²] | | | | | | | | | | |
| ak, −30° C. | 10.2 | 9.4 | 11.4 | 16.1 | 12.2 | 15.3 | 12.3 | 17.2 | n.d. | n.d. |
| [kJ/m²] | | | | | | | | | | |
| Color | 2 | 2 | 2 | 2 | 2 | 1-2 | 1-2 | 1-2 | 1-2 | 1-2 |
| W_{t, -30° C.} | 19.1 | 5.3 | 10.1 | 51.5 | 21.2 | 65.1 | 17.1 | 71.2 | 6.2 | 3.4 |
| [Nm] | | | | | | | | | | |
| C emiss. | 60 | 98 | 89 | 47 | 46 | 31 | 39 | 30 | 25 | 26 |
| [mg/kg] | | | | | | | | | | |

The molding compositions of the invention have improved flowability and colorfastness. In comparison with the prior art, products with markedly improved fracture energy at −30° C. can be obtained. Surprisingly, the products of the invention also have relatively low C emissions.

1.-11. (canceled)

12. A thermoplastic molding composition, comprising
a) as component A, from 3 to 79% by weight of one or more styrene copolymers which have no units derived from maleic anhydride,
b) as component B, from 15 to 91% by weight of one or more polyamides having, based on the entire component B, from 0.1 to 0.2% by weight of triacetonediamine (TAD) end groups,
c) as component C, from 5 to 50% by weight of one or more impact-modifying rubbers,
d) as component D, from 1 to 25% by weight of a styrene copolymer which, based on the entire component D, has from 1.9 to 2.3% by weight of units derived from maleic anhydride,
e) as component E, from 0 to 40% by weight of further rubbers,
f) as component F, from 0 to 50% by weight of one or more fibrous or particulate fillers,
g) as component G, from 0 to 40% by weight of further additives,
where the molding composition comprises less than 0.1% by weight of phthalic anhydride and the total amount of components A to D and, optionally, E to G does not exceed 100% by weight.

13. The molding composition according to claim 12, wherein component D has from 2.0 to 2.2% by weight of units derived from maleic anhydride.

14. The molding composition according to claim 13, wherein component D has about 2.1% by weight of units derived from maleic anhydride.

15. The molding composition according to claim 12, which comprises no phthalic anhydride.

16. The molding composition according to claim 12, wherein component B has from 0.14 to 0.18% by weight of triacetonediamine (TAD) end groups.

17. The molding composition according to claim 12, wherein component D is a styrene-acrylonitrile-maleic anhydride (MA) terpolymer.

18. The molding composition according to claim 12, wherein component A is a styrene-acrylonitrile copolymer.

19. A process for the production of thermoplastic molding compositions according to claim 12, which comprises mixing components A to D and optionally E to G with one another.

20. A molding, fiber, or foil comprising a thermoplastic molding composition according to claim 12.

21. The molding, fiber, or foil according to claim 20, wherein the molding is a motor-vehicle component or part of electronic equipment.
